(19) United States
(12) Patent Application Publication
(10) Pub. No.: US 2014/0073822 A1
(43) Pub. Date: Mar. 13, 2014

(54) Rotating Fluidized Bed Catalytic Pyrolysis Reactor

(71) Applicant: South Dakota State University, Brookings, SD (US)

(72) Inventors: Lin Wei, Brookings, SD (US); James Julson, Colman, SD (US)

(73) Assignee: South Dakota State University, Brookings, SD (US)

(21) Appl. No.: 13/936,188

(22) Filed: Jul. 7, 2013

Related U.S. Application Data
(60) Provisional application No. 61/668,574, filed on Jul. 6, 2012.

(51) Int. Cl. B01J 19/28; C10G 1/00

(52) U.S. Cl. CPC B01J 19/28; C10G 1/002
USPC 585/16; 585/240; 44/307; 422/209; 422/186.3; 422/187; 422/198

(57) ABSTRACT

Reactors for the pyrolysis of pyrolyzable matter, pyrolysis systems incorporating the reactors and methods of using the reactors are provided. Also provided are systems and methods for integrating the pyrolysis and hydrodeoxygenation of pyrolyzable matter. The pyrolysis reactors create a horizontally rotating, fluidized-bed to which pyrolyzable matter, such as biomass, may be converted via pyrolysis into liquid fuels and/or value-added chemicals.

### CROSS REFERENCE TO RELATED APPLICATION

This application claims benefit under 35 U.S.C. §119(e) to U.S. Provisional Application No. 61/668,574, filed Jul. 6, 2012, which is incorporated by reference herein in its entirety.

### REFERENCE TO GOVERNMENT RIGHTS

This invention was made with government support under SA0900160 awarded by the Department of Energy. The government has certain rights in the invention.

### BACKGROUND

Biomass is a source for renewable liquid fuel production. Undergoing a series of thermochemical reactions, called fast pyrolysis, biomass can be decomposed into a vapor-phase mixture of small molecules of organic compounds and a carbon-rich solid residue (known as bio-char) when it is heated in an oxygen-free environment. Sequentially, the vapor mixture can be separated from the bio-char using cyclones and/or filters. After separation, the vapor mixture can be condensed into a liquid-phase product (called bio-oil) using condensers at temperatures below 0° C., leaving non-condensable gaseous fractions (also called syngas) separated from bio-oil and bio-char.

Biomass fast pyrolysis is a very promising technology for producing renewable liquid fuels because bio-oil can be easily transported and stored, burned directly in thermal power stations for steam production to drive gas turbines, and upgraded or injected into a conventional petroleum refinery to obtain transportation liquid fuels (gasoline, diesel, and/or jet fuel) or value-added chemicals. Moreover, the byproducts, syngas and bio-char, can be used as biofuels or to produce value-added chemicals.

The properties and yield proportions of fast pyrolysis products (bio-oil, bio-char, and syngas) depend on the feedstock species used, reactor type, and operating conditions. Reaction temperature and pressure, heating rate, residence time, and the efficiencies of mass and energy transfer are critical operating parameters for a biomass fast pyrolysis process, and are affected by the structural design and operation of a pyrolysis reactor. A number of pyrolysis reactor designs are available. However, developing an efficient reactor with low cost for producing high quality bio-oil is challenging. For example, both bubbling and circulating fluidized-bed reactors can handle high biomass throughputs and bio-oil yields, however, the quality of bio-oil produced is low and the reactor operation is complicated due to the need for a large volumetric flow of high pressure carrier gas, such as nitrogen, that must be heated and compressed. Another type of pyrolysis reactor, an Auger reactor, can eliminate the need for a carrier gas, but the yield of bio-oil is low and the reactor scale is limited by low heat transfer efficiencies.

### SUMMARY

Reactors for the pyrolysis of pyrolyzable matter, pyrolysis systems incorporating the reactors and methods of using the reactors are provided. Also provided are systems and methods for integrating the pyrolysis and hydrodeoxygenation of pyrolyzable matter.

One embodiment of a reactor for the pyrolysis of pyrolyzable matter comprises: a horizontal, rotatable reactor drum comprising an annular wall disposed around a horizontal axis, wherein the annular wall is permeable to particulate material; a rotation drive connected to the rotatable reactor drum and configured to rotate the rotatable reactor drum about the horizontal axis; a feed conduit configured to transport pyrolyzable matter from a source of pyrolyzable matter into the rotatable reactor drum; and a reaction chamber in which the rotatable reactor drum and at least a portion of the feed conduit are housed.

One embodiment of a system for the pyrolysis of pyrolyzable matter comprises: the reactor described above; a source of pyrolyzable matter, wherein the source comprises particulate pyrolyzable matter and is configured to deliver the particulate pyrolyzable matter to the feed conduit; and heat transfer particles disposed within the rotatable reactor drum.

One embodiment of a method for pyrolyzing pyrolyzable matter comprises: (a) delivering particulate pyrolyzable matter into a horizontally rotating reactor drum having heat transfer particles disposed therein, wherein the rotating reactor drum comprises an annular wall that is substantially impermeable to the particulate pyrolyzable matter being delivered and to the heat transfer particles; and (b) horizontally rotating the rotatable reactor drum containing the resulting mixture of particulate pyrolyzable matter and heat transfer particles for a time, and at a temperature, sufficient to result in the pyrolysis of the particulate pyrolyzable matter to form a mixture of pyrolysis products comprising solid char particles and a vapor-phase comprising condensable organic molecules and non-condensable molecules; wherein the annular wall of the rotating reactor drum is substantially permeable to the solid char particles, such the solid char particles exit the rotating reactor drum through the annular wall.

One embodiment of a method for the integrated pyrolysis of pyrolyzable matter and hydrodeoxygenation of organic pyrolysis products comprises: pyrolyzing the pyrolyzable matter in a pyrolysis reactor in the presence of hydrogen and pyrolysis and hydrogenation catalysts, such that oxygenated organic pyrolysis product molecules undergo hydrogenation reactions in the pyrolysis reactor; separating solid pyrolysis products from vapor-phase products, the vapor-phase products comprising pyrolysis and hydrogenation products; and hydrodeoxygenating the separated vapor-phase products in the presence of hydrogen and a hydrodeoxygenation catalyst in a hydrodeoxygenation reactor.

In one aspect, a drop-in bio-fuel is disclosed, where the drop-in bio-fuel has a water content of less than about 0.2% wt. and an oxygen content of between about 1.4 to about 1.72% wt. In a related aspect, the oxygen content is less than about 2% wt.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 is a schematic diagram showing a cross-sectional view of one embodiment of a rotating fluidized-bed fast pyrolysis reactor.

FIG. 2 is a schematic diagram showing a cross-sectional view of the reactor drum taken along line ii-ii of FIG. 1 in the direction of the arrows.

FIG. 3 is a schematic diagram showing a cross-sectional side view of the reactor drum of FIG. 2.

FIG. 4 is a flow chart illustrating a system for the integration of the pyrolysis of pyrolyzable matter with the hydrodeoxygenation of pyrolysis products.

FIG. 5 shows a GC/MS analysis of the upgraded bio-oil produced from corn stover.

### DETAILED DESCRIPTION

Reactors for the pyrolysis of pyrolyzable matter, pyrolysis systems incorporating the reactors and methods of using the reactors are provided. Also provided are systems and methods for integrating the pyrolysis and hydrodeoxygenation of pyrolyzable matter.

The pyrolysis reactors create a horizontally rotating, fluidized-bed in which pyrolyzable matter, such as biomass, can be converted, via pyrolysis into liquid fuels and/or value-added chemicals. During the conversion process, the pyrolyzable matter is continuously fed into a rotating reactor drum that is housed within a reaction chamber where it comes into direct contact with a particulate heat transfer medium. Prior to the introduction of pyrolyzable matter into the rotating reactor drum, the particulate heat transfer medium is placed in the drum and pre-heated. The pyrolyzable matter is then continually pyrolyzed into a mixture of volatile organic compounds and solid-phase char particles. The product stream of volatile vapors and char particles can then exit the rotating reactor drum and enter a product separating unit, where the char particles are separated from the stream, a portion of the vapor is condensed into an oil, and another portion, comprising the syngas, is separated from the oil. The syngas can then be withdrawn from the pyrolysis reactor for use in downstream applications.

The rotating reactor drum blends the pyrolyzable matter entering the drum with the particulate heat transfer material to form a moving and rotating fluidized-bed for fast pyrolysis reactions. This design eliminates the need for a pressured inert carrier gas, such as those used to fluidize the bed in circulating fluidized bed pyrolysis reactors. Consequently, the pyrolysis reactor size can substantially reduced, the pressure drop inside of the reaction chamber can be decreased, the processing system can be simplified, and the processing cost can be reduced relative to other pyrolysis reactors.

Allowing the pyrolyzable feedstock to contact directly the particulate heat transfer material within the rotating fluidized bed enables the pyrolyzable matter to maintain continual contact with the large surface area provided by the particulate heat transfer material and with any catalysts, such as catalyst pellets, present in the rotating reactor drum. This can significantly increase the heating rate and the mass and energy transfer efficiencies between the pyrolysis reactants and the heat transfer material, and can also increase catalysis reaction rates and decrease the number of bed modules necessary for large system capacity, thereby improving the overall processing efficiency and product yield. Moreover, the resulting reduction in the reactant residence times helps to minimize abrasive wear on catalyst particles and, therefore, increases the lifetime of the catalyst.

A basic embodiment of the pyrolysis reactor comprises a reaction chamber in which pyrolysis is carried out, a feeding unit configured to introduce pyrolysis reactants into the reaction chamber and a product separating unit adapted to separate solid-phase pyrolysis products from vapor-phase pyrolysis products. A reactor drum configured to rotate about a horizontal axis (i.e., a rotatable reactor drum) is housed within the reaction chamber. The reactor drum is connected to a rotation drive that is configured to rotate the reactor drum about the horizontal axis. The feeding unit includes a feed conduit configured to transport pyrolyzable matter from a source of pyrolyzable matter into the reactor drum.

The rotatable reactor drum comprises an annular wall having an inner surface and an outer surface, wherein the inner wall defines an interior space. The annular wall is positioned annularly around the rotational axis about which the drum is configured to rotate when the reactor is in operation. An intake aperture, defined in a wall of the rotatable reactor drum, is provided to allow pyrolyzable matter to be introduced into the interior of the drum. The reactor drum can take on a variety of forms, both symmetric and non-symmetric. In some embodiments, the reactor drum has a cylindrical shape in which the annular wall is the cylinder wall and the intake aperture is defined in, or defined by, the end of the cylinder.

Within the reaction chamber, the rotatable reactor drum is disposed horizontally about a horizontal axis of rotation. As used herein, the terms “horizontal” and “horizontally” are used to indicate that the axis about which the reactor drum is configured to rotate runs perpendicular to, or substantially perpendicular to, the direction of earth's gravitational force. The term horizontal does not exclude configurations in which the reactor drum and the axis of rotation deviate somewhat from a perfect horizontal position, provided that the rotational axis is more closely aligned with the direction perpendicular to the direction of earth's gravitational force than with direction of that force.

The annular wall of the rotatable reactor drum is designed such that it is permeable to the solid char particles formed within the reactor drum during pyrolysis, but impermeable to the particulate pyrolyzable matter that is introduced into the reactor drum through the feed conduit, impermeable to heat transfer particles that are housed within the reactor drum and impermeable to particulate catalysts and/or particulate co-reactants housed within the reactor drum. As such, the annular wall is able to continuously expel solid, particulate pyrolysis products without expelling heat transfer particles, pyrolysis catalyst particles, or co-reactant particles. In some embodiments, the permeability of the annular wall can be provided by a plurality of holes that extend through the wall. The diameters of the holes will depend of the sizes of the reactant particles, heat transfer particles and any catalyst particles used. By way of illustration only, in some embodiments the holes have diameters of no greater than about 30 mm. This includes embodiments in which the holes have diameters in the range from 0.5 to 20 mm, further includes embodiments in which the holes have diameters in the range from 1 to 10 mm and still further includes embodiments in which the holes have diameters in the range from 1 to 5 mm.

The heat transfer particles can be made of a variety of materials provided they are able to absorb heat from a heat source and transfer the heat to the particles of pyrolyzable matter when they are placed in contact that matter. The heat transfer particles are desirably made of an inert material such that they do not participate in, or interfere with, the pyrolysis reactions. Examples of suitable materials for the heat transfer particles are sand and metals.

As mentioned above, other particles that may be held within the reactor drum include catalyst particles, such as pyrolysis catalyst pellets and/or hydrogenation catalyst pellets, and particles of co-reactants (i.e., reactants that react with the pyrolyzable matter during pyrolysis).

The feed conduit of the pyrolysis reactor is in fluid communication with the reactor drum and is configured to transport particulate pyrolyzable matter from a source of said matter into the interior of the reactor drum. As used herein, the phrase “in fluid communication with” is used to indicate that the designated components are connected through a path along which a material can travel from one location to another. The particular path can take on a wide variety of forms. The feed conduit defines an input aperture through which particles of a pyrolyzable matter are introduced into the conduit and an output aperture through which particles of pyrolyzable matter exit the conduit. The input and output apertures are connected by a channel. The feed conduit may further comprise a conveyor mechanism configured to continuously transport particulate matter along the channel from the input aperture to the output aperture. Examples of conveyor mechanisms include augers and conveyor belts.

The reactor drum and, desirably, at least a portion of the feed conduit are housed within a reaction chamber. The reaction chamber is designed to help contain vapor-phase pyrolysis products exiting the reactor drum and to allow for thermal isolation of the pyrolysis reaction environment. In some embodiments, the reaction chamber defines an annular space around the rotatable reactor drum and the portion of the feed conveyor. This annular space, which may take a variety of shapes, is in fluid communication with the rotatable reactor drum such that vapor-phase pyrolysis products formed in the rotatable reactor drum are able to flow into the annular space around the feed conduit. Using this design, the vapor-phase product stream can be used to heat the feed conduit, such that the particulate pyrolyzable matter carried within is pre-heated when it is introduced into the reactor drum.

The interior of the reaction chamber and, more specifically, the interior of the reactor drum, can be heated by one or more heat sources disposed exterior to the reaction chamber, disposed interior to the reaction chamber, but exterior to the reactor drum, and/or disposed within the reactor drum. Suitable heat sources include radiation (e.g., UV radiation) sources, contact heaters and fuel burners. In some embodiments of the reactors, a heat source is provided at the center of the reactor drum. By providing a heat source at the center of the reactor drum for large scale reactors, the maximum amount of available heat can be utilized, the need for expensive quartz windows used in some current reactors can be eliminated and particles can be kept away from the radiation source.

The product separating unit is in fluid communication with the reaction chamber and positioned to accept both solid- and vapor-phase pyrolysis products exiting the reaction chamber. Various product separating units can be employed, including cyclone-type filters. The product separating unit generally comprises a product collection chamber having an input port in fluid communication with the reaction chamber and an output port which may be in fluid communication with a downstream processing device, such as a condenser. In some embodiments, the product separating unit further comprises a product conducting channel that extends from the reaction chamber into the product collection chamber and further comprises a filter housed within the product collection chamber and disposed around the product conduction channel, such that vapor-phase pyrolysis products entering the product collection chamber through said channel will pass through the filter before they can exit through the product collection chamber's output port. In some embodiments, the product collection chamber is positioned directly below the reactor drum such that solid char particles drop from the drum into the product collection chamber.

Methods for using the present pyrolysis reactors comprise the steps of delivering particulate pyrolyzable matter into a horizontally rotating reactor drum into which heat transfer particles and, optionally, catalyst particles and/or co-reactant particles have been pre-inserted, and horizontally rotating the reactor drum for a time and at a temperature sufficient to result in the pyrolysis of the particulate pyrolyzable matter. Examples of pyrolyzable matter include biomass, which is a composite of cellulose, hemicelluloses and lignin. Sources of biomass include, but are not limited to, wood, plants, tunicates, algae and bacteria.

As the reactor drum rotates, the solid particle bed contained therein undergoes a tumbling motion that creates a fluidized particle bed without the need for pressurized carrier gases. In fact, the present pyrolysis methods can be carried out at ambient air and at atmospheric pressure. Alternatively, in some embodiments an elevated pressure, such as a pressure up to about 10 atm, is employed. Typical pyrolysis reaction temperatures in the reactor drum are in the range of about 200 to about 800° C. Typical reactor drum rotation rates are in the range from about 20 to 800 RPM.

Because the annular wall of the reactor drum is substantially impermeable to the solid char particles produced via pyrolysis, those char particles continuously pass out of the reactor drum through the annular wall. As used herein, the phrase “substantially impermeable” is used to indicate that a majority of the char particles are able to pass through the annual wall. The expelled char particles and the vapor-phase pyrolysis products can then be collected in the product collection chamber, wherein the vapor-phase products are separated from the char and other solids. Finally, the condensable organic molecules can be condensed from the vapor-phase to provide a liquid product, such as a fuel oil. Condensable organic molecules that may be formed by pyrolysis include saccharides, anhydrosugars, aldehydes, furans, ketones, alcohols, and carboxylic acids.

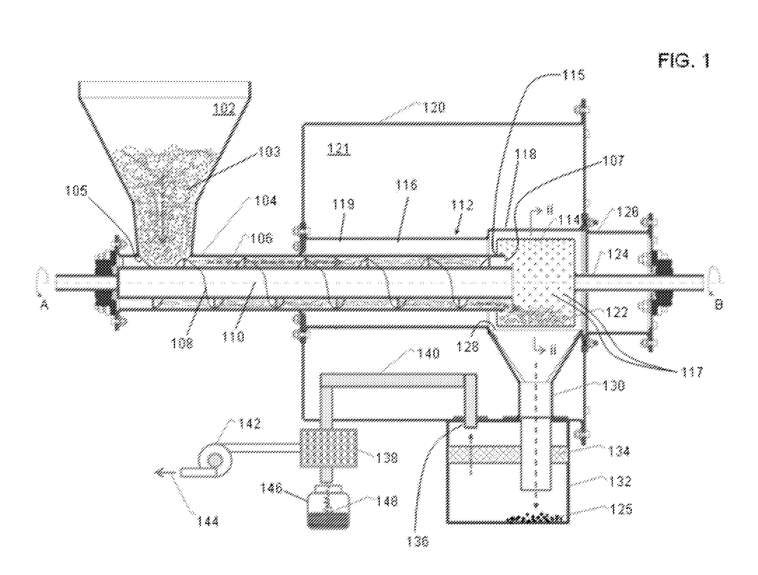

FIG. 1 is a schematic diagram showing a cross-sectional view of one specific embodiment of a rotating fluidized-bed fast pyrolysis reactor. In the embodiment depicted in this figure, the feed unit comprises a screw-type conveyor feeder. This feeder comprises of a biomass hopper 102, a feed conduit 104, and an auger 106 housed within the feed conduit and comprising an auger blade 108 that defines a helical coil about a coil axis that coincides with the central longitudinal axis 110 of feed conduit 104. Biomass hopper 102 contains a plurality of biomass particles 103. Feed conduit 104 defines an input aperture 105 through which biomass particles 103 from biomass hopper 102 are introduced into the conduit. A valve (not shown), such as an air-lock valve, can be installed to control (start and stop) the flow of biomass particles from biomass hopper 102 into feed conduit 104. Feed conduit 104 further defines an output aperture 107, positioned downstream from input aperture 105, through which biomass particles 103 exit the conduit. Auger 106 is connected to and rotated by a first driving motor (not shown), as indicated by arrow ‘A’. The biomass feeding rate can be controlled by the rotation speed or auger 106, desirably with a minimum feeding rate of zero.

The pyrolysis reactor comprises an interior reaction chamber 112 in which a horizontally rotatable reactor drum 114 and a portion of feed conduit 106 are housed. In this embodiment, reaction chamber 112 comprises two serially joined pipes 116, 118 having different diameters. In this configuration, an annular space 119 is formed between feed conduit 106 and pipes 116, 118. The pyrolysis reactor further comprises an exterior housing 120 disposed around reaction chamber 112 and configured to provide thermal isolation for that chamber. The interior space 121 provided by exterior housing 120 can be filled with thermal isolation materials, such as silica, ceramic foam or glass fiber. Pipes 116 and 118 can be heated separately and, therefore, are able to provide two reaction sub-chambers characterized by heating zones having different temperatures. For example, each of pipes 116 and 118 can have a separate electrical heater mounted on its outer surface. However, other types of heating sources, such as hot air, electromagnetic radiation or infrared radiation can also be used.

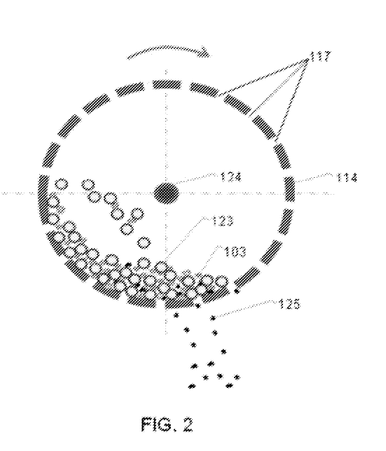

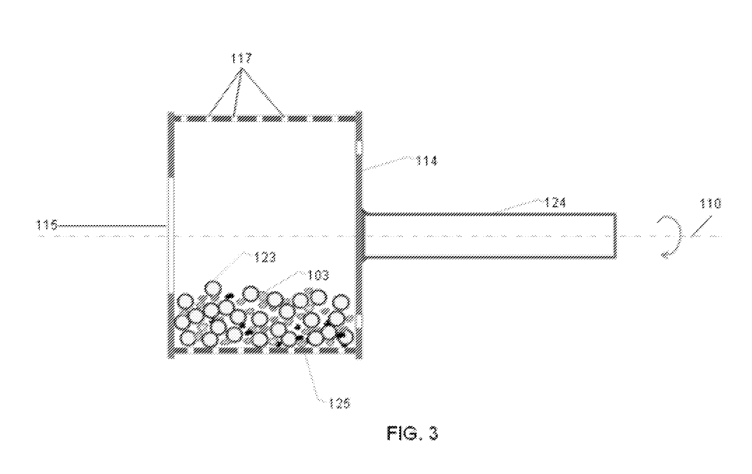

Rotatable reactor drum 114 defines an intake aperture 115 into which feed conduit 106 extends and through which biomass particles 103 can be introduced into the drum. FIGS. 2 and 3 provide enlarged cross-sectional views of rotatable reactor drum 114. FIG. 2 provides a view of reactor drum 114 taken along line ii-ii of FIG. 1 in the direction of the arrows. FIG. 3 provides a side view of reactor drum 114. During operation of the reactor, rotatable reactor drum 114 will contain a fluidized bed comprising a mixture of solid particles 122 made up of some combination of biomass particles 103, heat transfer particles 123, bio-char particles 125 and, typically, catalyst particles (not shown). In a related aspect, catalysts may include, but are not limited to, those formulated from noble metals with supports of zeolite (e.g., ZSM-5, available from ACS Material, LLC, Medford, Mass.), aluminum oxide, or carbon based catalysts such as those sold under the name AMBERLYST (Rhom & Haas).

In the embodiment of FIG. 1, rotatable reactor drum 114 comprises an annular wall having in inner surface and an oppositely disposed outer surface. The annular wall is positioned annularly around the rotational axis 110 of the drum. The annular wall defines a plurality of holes 117 that extend from its inner surface to its outer surface and that are sized to retain heat transfer particles 123 and any catalyst particles within the reactor drum, while allowing bio-char particles 125 to pass out of the reactor drum 114 and, subsequently, out of reaction chamber 112 through an output aperture 128 disposed below rotatable reactor drum 114. Rotatable reactor drum 114 is connected to and rotated by a second driving motor (not shown), such as a variable speed motor, as indicated by arrow ‘B’. As shown in the figure, the connection can be made by a driving rod 124 (e.g., a bar) connected to reactor drum 114 and positioned opposite intake aperture 115. In the embodiment shown here, a cooling chamber 126 is disposed around rod 124. Cooling chamber 126 can be filled with a coolant material, such as an oil.

The use of a variable speed motor to drive the reactor drum allows the rotating drum to operate in a range of low to intermediate speeds, providing flexibility for feeding biomass reactants having a variety of particle size distributions and biomass types. This flexibility can provide the reactors with a reduced need for biomass feedstock pretreatment, lower overall processing costs, better temperature control, reduced reactant retention time, and improved reactor performance relative to other known pyrolysis reactors. Moreover, the use of a variable speed motor allows the void fraction in the fluidized-bed, the bed density and, consequently, the blending of biomass and particulate heat transfer material to be controlled with greater uniformity.

Optionally, a heat source may be disposed within rotatable reactor drum 114 and configured to heat the reactants in the fluidized bed. Examples of suitable heat sources include radiation sources, such as UV lamps. In some embodiments the radiation source is a cylindrical lamp disposed within the reactor drum and positioned annularly about the rotational axis of the drum.

The product separating unit is configured to accept a mixture of pyrolysis products, including bio-char, bio-oil and bio-syngas, from the reaction vessel. In the embodiment shown in FIG. 1, these pyrolysis products pass into the separation unit through a product conducting channel 130 that extends between the reaction chamber 112 and the product separating unit and opens into the interior of a pyrolysis product collection chamber 132. A filter 134 housed within product collection chamber 132 is configured such that vapor-phase pyrolysis product exiting product conducting channel 130 will pass through the filter to remove any ash or unconverted bio-mass and bio-char particles before it exits product collection chamber 132 through exit port 135. Exit port 136 is in fluid communication with a condenser 138 via a connecting conduit 140. A suction draft blower 142 connected to an outlet of condenser 138 is configured to maintain a negative pressure in interior reaction chamber 142 and to draw off non-condensable gases 144 from condenser 138. As used herein, the term non-condensable gas refers to chemical compounds having a low dew point (below 0° C.) that do not condense into the liquid phase at atmospheric pressure. Examples of non-condensable gases include CO, CO₂, H₂ and CH₄. A condenser product chamber 146, is configured to collect condensed product 148, including bio-oil, exiting the condenser.

A process for the pyrolysis of biomass using the reactor of FIG. 1 can comprise the following steps. When the reactor is in operation, motor B drives driving rod 124 and rotates reactor drum 114 while heaters heat the two sub-chambers of interior reaction chamber 112. As the temperatures of sub-chambers rise, the heat transfer particles and catalyst particles, which are present in reactor drum 114 from the outset of the process, are evenly heated because they are rotating continually and in direct contact with the annular wall of the reactor drum.

Once interior reaction chamber 112 reaches a pre-selected elevated temperature (typically a temperature in the range from about 200° C. to about 800° C.), biomass particles 103 are conveyed through feed conduit 104 by auger 106, which is driven by motor A, until they are deposited into reactor drum 114, where they mix with heat transfer particles 123 and catalyst particles. When the biomass particles 103 travel through feed conduit 104, they may be warmed up by the hot, vapor-phase pyrolysis product stream exiting reactor drum 114 into annular space 119, while said vapor-phase product stream is correspondingly cooled down.

The preheated biomass particles 103 are desirably fed into reactor drum 114 at a low ratio of biomass to heat transfer particles. The solid particles of the resulting particle mixture 122, which are initially held against the lower portion of the annular wall of reactor drum 114, move in the direction of drum rotation under the combined effects of centrifugal forces and the friction between the particles and the annular wall of the drum. The solid particle mixture 122 rotates upward as the drum rotates until particle mixture 122 falls back to the particle bed held in the lower portion of reactor drum 114 under the force of gravity. This continual rotating/falling motion of the particles creates a moving fluidized-bed.

Once biomass particles 103 have been pyrolyzed in reactor drum 114 into solid bio-char and a vapor-phase comprising, or consisting essentially of, organic compounds and water vapor, the pyrolysis product stream is drawn away from interior reaction chamber 112 through conducting channel 130 and into pyrolysis product collection chamber 132, where it is separated into three products: bio-char, bio-oil, and bio-syngas (the non-condensable gases). Solids, such as ash, un-converted biomass and bio-char particles are separated from the product vapor stream by filter 134 and stay inside product chamber 132. The remaining vapor-phase product stream is drawn out of product collection chamber 132 and travels through connecting conduit 140 to condenser 138, where the condensable components in the vapor are condensed into liquid bio-oil 148, which is collected in condenser product chamber 146. The remaining non-condensable gases 144 are drawn off from condenser 138 by blower 142 for further processing or to burn to provide heat for the pyrolysis process.

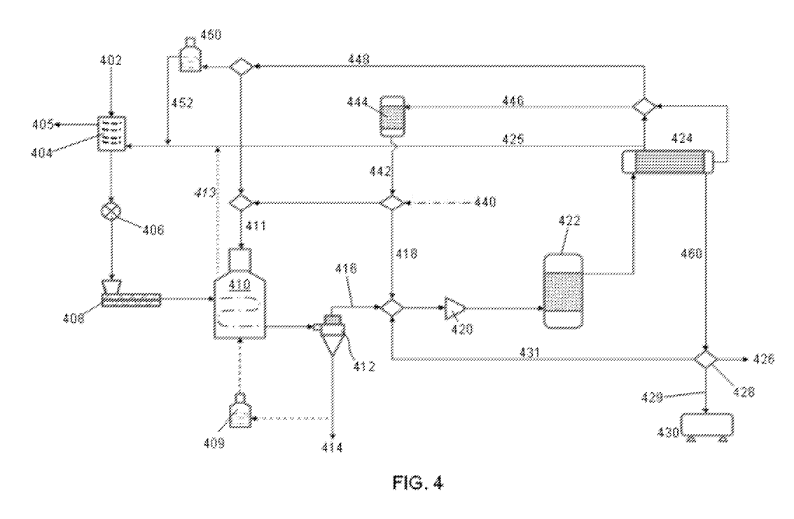

Another aspect of the invention provides systems and methods for integrating the pyrolysis of pyrolyzable matter with the hydrodeoxygenation (HDO) of vapor-phase, organic pyrolysis products to provide for the continuous conversion of the pyrolyzable matter into liquid hydrocarbon fuels and other value-added liquid products. FIG. 4 provides a flowchart illustrating such a system. In this system the pyrolyzable matter can be, for example, solid biomass 402. Solid biomass 402 can be prepared for pyrolysis by chopping it into to small pieces (e.g., into particles having a mean size (diameter)<50 mm), then placed into a dryer 404 to reduce its moisture content (MC) to a value of, for example, less than about 10 wt. % (wet basis) by expelling water 405. The dried biomass may then be ground into a powder using a grinder 406. By way of illustration only, a typical mean particle size for the powder is less than about 3 mm. This biomass powder is then fed via a feeding unit 408 into a pyrolysis reaction chamber 410 where it is pyrolyzed into a vapor-phase comprising organic compounds and water vapor. Pyrolysis reaction chamber 410 can be heated with an external heat source 409, such as a gas burner. Within the reaction chamber heat carrying particles aid and speed up the pyrolysis process. In some embodiments, the biomass feeding unit and the reaction chamber of the above-described rotating fluidized-bed fast pyrolysis reactor are used as feeding unit 408 and reaction chamber 410, respectively. Hydrogen gas 411 is introduced into reaction chamber 410 and, in the presence of pyrolysis catalysts and/or hydrogenation catalysts present in the reactor, results in the hydrogenation of oxygenated bio-oil compounds produced via pyrolysis. The hydrogenation reactions saturate the product hydrocarbons, which results in more stable hydrocarbons having a higher H/C ratio and less heavy tar. This is advantageous because it reduces catalyst fouling problem and improves catalyst activity during the conversion process that takes place in the downstream HDO reactor. Hydrogen 411 may be purchased hydrogen 440 or may be hydrogen obtained from a water-gas-shift (WGS) reaction 442 using WGS reactor 444 that recycles non-condensable syngas 446 collected from the downstream HDO reactor. Optionally, hot air 413 from the pyrolysis/hydrogenation reactions can be recycled to provide heat to dryer 404.

The vapor- and solid-phase pyrolysis and hydrogenation products then pass out of reaction chamber 410 and into a filtration device 412, such as a cyclone-type filter, where the solid product particles 414 comprising bio-char and ash residues are separated from the vapor-phase product stream 416. The separated bio-char can be activated and used as a catalyst support material or an activated carbon, or as a process fuel or a soil additive. The vapor-phase products 416 are combined with hydrogen gas 418 an additional time and compressed by a compressor 420 before they enter an HDO reactor 422, such as a tubular fixed-bed reactor, where hydrodeoxygenation catalysts reduce the oxygen content and hydrocrack the heavier portion of the hydrocarbons into gasoline and diesel ranged hydrocarbons, that, when condensed in condenser 424, are of the quality necessary to allow insertion into a petroleum refinery's hydrocracker and isomerization units. The compressor 420 is a vapor compressor in which the vapor streams are compressed to an elevated pressure, typically in range from about 1 to about 30 atm, before they enter the hydrodeoxygenation reactor. Optionally, steam 425 from condenser 424 can be fed back as a heat source for dryer 404. The non-condensable gases 446 may be sent to WGS reactor 444, as discussed above, or may be burned as a fuel 448 in burner 450 to supply hot air 452 as a heat source for dryer 404. Notably, this integrated process can be carried our with condensation and re-evaporation steps in between pyrolysis and hydrodeoxygenation.

The condensed upgraded bio-oil hydrocarbons 460 from condenser 424 have a lower density than, and are substantially insoluble in, water. Thus, these liquid hydrocarbon biofuels 426 can be separated from the two-phase system by separator 428. The remaining aqueous products 429 can be either recycled back into the bio-oil upgrading stream 431 for increasing bio-oil yield or collected in liquid collector 430 for further conversion into ethanol by fermentation, or into other value-added chemicals.

Several features will be apparent to one of skill in the art, including 1) no inert gas is needed within the reactor chamber, 2) catalytic pyrolysis can occur within the CFP reactor, 3) feedstock particle size can be more variable and larger than current pyrolysis technologies, 4) catalytic and sand or other heat carrying devices remain in the reactor, no separation or recycling is required, 5) temperature is easily controlled, 6) high heat transfer rates are achieved, 7) the reactor is scalable, and 8) the reactor can convert multiple feedstocks including waste wood, crop residues and grasses.

As used herein, “illustrative” means serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise.

As used herein, “drop-in bio-fuel” means biofuels that are completely interchangeable with conventional fuels. For example, the drop-in fuel may be “FT-SPK” which means processing solid biomass using pyrolysis to produce pyrolysis oil or gasification to produce a syngas which is then processed into FT SPK (Fischer-Tropsch Synthetic Paraffinic Kerosene).

### EXAMPLES

### Feedstock Preparation and Feeding.

In this Example, to collect observed bio-oil sample, 500 grams of corn stover was used to feed in the reactor. Biomass (i.e., corn stover) was chopped into small pieces less than about 20 mm in size, dried to MC of less than about 8%, and then ground into powder with a particle size of less than about 3 mm. The dried biomass was then fed into the CFP reactor for pyrolysis. The yield rate of raw bio-oil is about 65%.

### Pyrolysis and Hydrogenation.

The corn stover powder in the CFP was decomposed into a mixture of non-condensable syngas, raw bio-oil (organic compounds and water vapor) and solid bio-char at a temperature which ranged from about 400 to about 600° C., at about 1 ATM pressure. Inside the reactor, while the corn stover powder was decomposing, oxygenated compounds of raw bio-oil vapor were hydrogenated into more stable hydrocarbon vapors in the presence of hydrogen, heat carrying particles and solid catalyst particles. The hydrogen used was generated from the co-products (i.e., non-condensable syngas) produced by the corn stover powder decomposition. Use of this source of hydrogen for hydrogenation is applicable where outside hydrogen is injected to increase hydrogen concentration inside the reaction chamber. Catalysts like zeolite based Ni, Cu, Co, have been tested and used in these reactions with success. The ratio of biomass to catalyst ranged from about 0.5 to 2. These hydrogenation reactions saturate the hydrocarbons, producing a higher H/C ratio of up to about 1.2-2.2 (from corn stover, about 0.2-0.8), thereby producing a more stable hydrocarbon vapor. Quality hydrocarbon vapors, containing less heavy tars, significantly improve catalyst activity and life cycle length in the subsequent HDO reactor. The hydrogen gas needed may be purchased or obtained from a water-gas-shift (WGS) reaction by recycling the non-condensable syngas produced.

### Bio-Char Separation.

The pyrolysis and hydrogenation products streams exit from the CFP reactor and into a cyclone filtering separator to remove solid products (e.g., un-converted bio-char and ash residues). One or more additional filters may be used. Activated carbon may be used as a support material for the catalysts used in the HDO reactor, as such, bio-char may be used to serve the same purpose.

### Bio-Oil HDO Upgrading.

Hydrocarbons and water vapors were combined with a second addition of hydrogen, which combination was slightly compressed prior to entering the HDO reactor. Within the HDO reactor, hydrocarbon vapors were deoxygenated and hydrocracked to remove oxygen and convert the heavy, long chain hydrocarbons to lighter, short chain hydrocarbons that may be inserted into petroleum refinery hydrocracker and/or isomerization units.

### Upgraded Bio-Oil Condensation.

Upon exiting the HDO reactor, the vapor of upgraded hydrocarbons and aqueous compounds were transferred to a condenser, where the mixture was condensed into a two phase liquid mixture, separated from the syngas stream. The non-condensable gases stream were either sent to a water-gas-shift (WGS) reactor to produce hydrogen for the process (see above) or burned as fuel to supply energy for the process.

### Separation of Liquid Hydrocarbon Drop-In Fuels.

The condensed upgraded bio-oil hydrocarbons have lower density and are mostly insoluble in water. Thus, they were easily separated from the two-phase liquid mixture and collected for storage. Remaining aqueous products were either recycled back to the bio-oil upgrading stream for increasing bio-oil yield or collected in a liquid tank for further conversion into ethanol by fermentation, or value added chemicals by other processes.

### Bio-Oil Analysis.

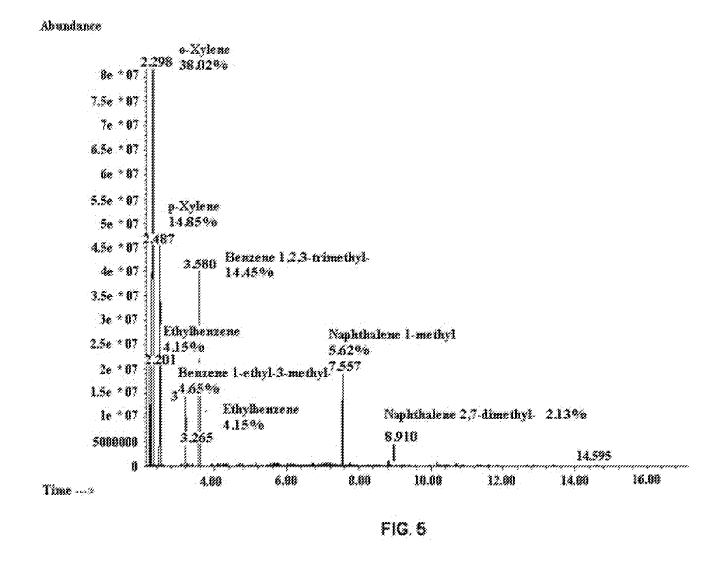

Baseline bio-oil feedstock was produced from corn stover and sawdust using the reactor as described, with a yield of up to 65% raw bio-oil. Different catalyst formulation (as described above) were developed and tested with success. Sequentially upgrading raw bio-oil in a separate hydrodeoxygenation (HDO) reactor produced a high quality upgraded bio-oil, at a yield of approximately 10%. A typical GC/MS analysis of the upgraded bio-oil so produced is shown in FIG. 5. The GC/MS analysis was conducted with an Agilent GC/MS (7890A/5975C), followed by identifying which compounds were present with the NIST08 Mass Spectral Library. Over 85% (area) of aromatic hydrocarbons (in the range of C₆-C₁₂) were identified in the upgraded bio-oil. In accordance with ASTM standards (D2591, D-3228, E-385, D4057, D445, D5762, D1298, etc.), the determination of physical and chemicals properties of samples of raw bio-oil and upgraded oil was completed. The C, H, N, O contents of the bio-oil samples were determined using an elementary analyzer (Perkin 2400 CHN Analyzer). The water content was measured using a Viscoanalyzer (ATS Rheosystems). The energy contents were measured using a bomb calorimeter (Parr 1341). The pH values were measured using a pH meter (Fisher Scientific AACCUMET AB 15).

A side-by-side comparison of the corn stover based raw bio-oil, upgraded bio-oil and petroleum based gasoline, diesel, and jet fuel is shown in Table 1.

TABLE 1
Comparison of raw bio-oil and upgrade bio-oil, produced from corn
stover and petroleum based gasoline, diesel, and jet fuel.

| | Raw | Upgraded | Gaso- | Petro- | |
|---|---|---|---|---|---|
| Properties | bio-oil | bio-oil | line | diesel | JP-8 |
| pH value | 2.8-3.2 | 5.0-5.6 | — | — | — |
| Freezing | — | −18 | −40 | −10 | −50 |
| point, ° C. | | | | | |
| Viscosity | 20-5.0 | 1.22-1.88 | 0.4-0.8 | 1.9-4.1 | 0.89-1.28 |
| cSt@20° C. | | | | | |
| Density, | 0.9-1.06 | 0.8-0.85 | 0.745 | 0.832 | 0.81 |
| Kg/L | | | | | |
| Heating | 16-23 | 41-45 | 43 | 42 | 43 |
| value, MJ/kg | | | | | |
| Carbon | 24-28 | 84.59-85.12 | 85-88 | 87 | 86 |
| content, % wt. | | | | | |
| Hydrogen | 8.5-10.1 | 10.9-11.26 | 12-15 | 13 | 14 |
| content, % wt. | | | | | |
| Oxygen | 35-40 | 1.4-1.72 | 0 | 0 | 0 |
| content, % wt. | | | | | |
| Water | 35-47 | <0.2% | 0 | 0 | 0 |
| content, % wt. | | | | | |

The data indicates the upgraded bio-oil produced is very similar to petroleum in terms of physical and chemical properties, including hydrocarbon content. Those characteristics allow the bio-oil of the present disclosure to be slipstreamed into a traditional petroleum refinery hydrocracker and/or isomerization units for conversion to “green to renewable” gasoline and diesel.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A reactor for pyrolysis comprising:
a horizontal, rotatable reactor drum comprising an annular wall disposed around a horizontal axis, wherein the annular wall is permeable to particulate material;
a rotation drive connected to the rotatable reactor drum and configured to rotate the rotatable reactor drum about the horizontal axis;
a feed conduit configured to transport pyrolyzable matter from a source of pyrolyzable matter into the rotatable reactor drum; and
a reaction chamber in which the rotatable reactor drum and at least a portion of the feed conduit are housed.

2. The reactor of claim 1, wherein the annular wall defines a plurality of holes that extend through the annular wall, the holes having diameters in the range from about 0.5 to about 30 mm.

3. The reactor of claim 1, wherein the reaction chamber forms an annular space around the rotatable reactor drum and at least a portion of the feed conduit, and further wherein the annular space is in fluid communication with the rotatable reactor drum, such that vapor-phase pyrolysis products formed in the rotatable reactor drum are able to flow into the annular space.

4. The reactor of claim 1, further comprising a radiation source disposed within the rotatable reactor drum and configured to emit radiation toward the annular wall.

5. The reactor of claim 4, wherein the radiation source emits ultraviolet radiation.

6. The reactor of claim 1, further comprising:
a product collection chamber, the product collection chamber comprising an input port and an output port;
a product conducting channel extending from the reaction chamber into the product collection chamber through the input port and configured to conduct pyrolysis products from the reaction chamber into the product collection chamber; and
a filter housed within the product collection chamber and disposed around the product conduction channel, wherein the filter is configured such that vapor-phase pyrolysis products entering the product collection chamber through the product conducting channel will pass through the filter before they can exit through the output port.

7. The reactor of claim 6, further comprising:
a condenser in fluid communication with the output port of the product collection chamber; and
a negative pressure device configured to create a negative pressure via a compressor within the product collection chamber, relative to the reaction chamber, such that vapor-phase pyrolysis products formed in the rotating reactor drum will be drawn into the product collection chamber through the product conducting channel and subsequently drawn into a condenser.

8. A system for the pyrolysis of a pyrolyzable matter, the system comprising:
a pyrolysis reactor comprising:
a horizontal, rotatable reactor drum comprising an annular wall disposed around a horizontal axis, wherein the annular wall is permeable to particulate material;
a rotation drive connected to the rotatable reactor drum and configured to rotate the rotatable reactor drum about the horizontal axis;
a feed conduit configured to transport pyrolyzable matter from a source of pyrolyzable matter into the rotatable reactor drum;
a reaction chamber in which the rotatable reactor drum and at least a portion of the feed conduit are housed;
a source of pyrolyzable matter, wherein the source comprises particulate pyrolyzable matter and is configured to deliver the particulate pyrolyzable matter to the feed conduit; and
heat transfer particles disposed within the rotatable reactor drum;
wherein the annular wall of the rotatable reactor drum is substantially impermeable to the particulate pyrolyzable matter.

9. The system of claim 8, further comprising pyrolysis catalyst particles disposed within the rotatable reactor drum, wherein the annular wall of the rotatable reactor drum is substantially impermeable to the pyrolysis catalyst particles.

10. The system of claim 8, wherein the pyrolyzable matter comprises biomass.

11. A method for pyrolyzing pyrolyzable matter, the method comprising:
(a) delivering particulate pyrolyzable matter into a horizontally rotating reactor drum having heat transfer particles disposed therein, wherein the rotating reactor drum comprises an annular wall that is substantially impermeable to the particulate pyrolyzable matter being delivered and to the heat transfer particles; and
(b) horizontally rotating the rotatable reactor drum containing the resulting mixture of particulate pyrolyzable matter and heat transfer particles for a time, and at a temperature, sufficient to result in the pyrolysis of the particulate pyrolyzable matter to form a mixture of pyrolysis products comprising solid char particles and a vapor-phase comprising condensable organic molecules and non-condensable molecules;
wherein the annular wall of the rotating reactor drum is substantially permeable to the solid char particles, such that the solid char particles exit the rotating reactor drum through the annular wall.

12. The method of claim 11, wherein the particulate pyrolyzable matter is not mixed with heat transfer particles prior to its delivery into the rotating reactor drum.

13. The method of claim 11, wherein the solid char particles are continuously expelled from the rotating sector drum as the particulate pyrolyzable matter is continuously delivered into the horizontally rotating reactor drum.

14. The method of claim 11, wherein the pyrolysis is carried out in the absence of an inert carrier gas and at a pressure no greater than about 10 atm.

15. The method of claim 11, wherein the reaction chamber forms an annular space around the reactor drum and at least a portion of the feed conduit, and further wherein the annular space is in fluid communication with the rotatable reactor drum, such that the vapor-phase pyrolysis products exiting the rotatable reactor drum flow into the annular space and heat the portion of the feed conduit housed within the reaction chamber.

16. The method of claim 11, wherein the mixture of particulate pyrolyzable matter is heated using a source of ultraviolet radiation.

17. The method of claim 11, further comprising collecting the solid char particles, the condensable organic molecules and the un-condensable molecules in a product collection chamber and separating the condensable organic molecules and the un-condensable molecules from the solid char particles.

18. The method of claim 17, further comprising condensing the condensable organic molecules.

19. A method for the integrated pyrolysis of pyrolyzable matter and hydrodeoxygenation of organic pyrolysis products, the method comprising:
pyrolyzing the pyrolyzable matter in a pyrolysis reactor in the presence of hydrogen and pyrolysis and hydrogenation catalysts, such that oxygenated organic pyrolysis product molecules undergo hydrogenation reactions in the pyrolysis reactor;
separating solid pyrolysis products from vapor-phase products, the vapor-phase products comprising pyrolysis and hydrogenation products; and
hydrodeoxygenating the separated vapor-phase products in the presence of hydrogen and a hydrodeoxygenation catalyst in a hydrodeoxygenation reactor.

20. The method of claim 19, wherein there are no condensation and re-evaporation steps in between pyrolysis and hydrodeoxygenation.

21. The method of claim 19, further comprising compressing the vapor-phase pyrolysis products and hydrogen are compressed to a pressure in the range from about 1 to about 20 atm before entering the hydrodeoxygenation reactor.

22. A drop-in bio-fuel obtained by the method of claim 19, wherein said drop-in bio-fuel has a water content of less than about 0.2% wt. and an oxygen content of less than about 2% wt.
